(19) United States
(12) Patent Application Publication
(10) Pub. No.: US 2008/0102185 A1
(43) Pub. Date: May 1, 2008

(54) Gel in water suspensions comprising cocoa products and beverages made from them

(76) Inventor: William Hanselmann, Hershey, PA (US)

Correspondence Address: WILEY REIN LLP, 1776 K. STREET N.W., WASHINGTON, DC, 20006, US

(21) Appl. No.: 11/585,986

(22) Filed: Oct. 25, 2006

(51) Int. Cl. A23G 1/00

(52) U.S. Cl. 426/593; 426/573

(57) ABSTRACT

The invention provides, in one aspect, a method of making a cocoa-containing beverage product or ingredient by mixing a gel network into micro-particles to form a gel-in-water suspension. The continuous phase of the suspension is preferably water or a milk, such as skim milk. Various beverage products, cocoa-containing products, and highly-concentrated cocoa flavanol-containing beverages are also disclosed.

### FIELD OF THE INVENTION AND INTRODUCTION

The invention relates to methods for producing a suspension of cocoa components in water or aqueous solution, where the cocoa components are first formed into a gel network and then dispersed into particles that remain in an aqueous suspension, referred to as a gel-in-water suspension. The suspension typically contains a cocoa-based or biomaterial gel micro-particles dispersed into a continuous phase that is typically water or a milk product. The methods are especially useful in producing novel cocoa beverages that contain high concentrations of cocoa products and/or cocoa antioxidants, and have excellent flavor and mouthfeel.

### DESCRIPTION OF RELATED ART AND BACKGROUND TO THE INVENTION

Most beverage products take the form of solutions or suspension of a solid material in a liquid. Similar but also different compositions typically referred to as puddings take the form of a gelled product or a mixture of gelled products. While the gelled products can be made fairly viscous, the beverage products employing a gel have substantial problems staying in a suspension and almost universally become a solution and a layer of un-dissolved or out-of-suspension materials, at least over the course of a typical product shelf life.

For example, in the patent document of Somerville (U.S. Pat. No. 6,485,771), the conventional gel is suspended in a second gel or hydrocolloid gel. The depicted examples are pudding or flan-like compositions that incorporate a novel appearance from the two gel components used. As discussed in this Somerville document, a particulated gel is a first component and a hydrocolloid component forms the continuous phase of the final composition. The hydrocolloid phase is formed from the known gums, whey, and starches typically used in the art.

The potential variations in viscosity of such a product are limited. Also, as the gels used become more concentrated in a gel-forming component, the potential for producing a liquid essentially disappears. Thus, the art is in need of methods and products that have a range of gel-like components that can also be made into palatable beverages.

### SUMMARY OF THE INVENTION

In one aspect, the invention comprises a method of producing a beverage composition where a cocoa-containing composition, such as cocoa powder, is heated to form a gel or gel network. In general, a composition comprising at least about 2% of cocoa-containing (cocoa solids-containing) product is used. The gel network formed is mixed with water or a liquid or aqueous solution at relatively high shear strengths to form a suspension of gel micro-particles. The micro-particles can vary in maximum size or average particle size but preferably are substantially all less than about 100 microns in diameter.

In a general aspect, the invention comprises a method of first producing what is referred to as a gel network microstructure, and an exemplary gel network is discussed in published applications US 2006/0121175 and US 2006/0121164. However, in contrast to the ingredients used in the gel networks of these prior applications, the gel network or microstructure used first in this invention can be formed of a subset of the complete ingredients, such as for example simply a cocoa product, preferably cocoa powder, and water. There are obvious cost savings and processing improvements possible in using simply water. Furthermore, the cocoa product or cocoa powder can be or comprise finely ground cocoa such that the average particle size of the cocoa particles can be less than 10 microns in size, or about 1-5 microns in size. In further contrast with the prior applications listed above, this first gel network can then be combined with other ingredients or another gel network, for example a second gel network formed with one or more milk products, and mixed at high speed or under conditions that produce micro-particles in the range of less than 50 microns average diameter, or even less than 10 microns or about 1-5 microns in average size. The combination product results in characteristics especially useful for producing beverage compositions, stable beverage suspensions, and highly concentrated beverage compositions that retain acceptable beverage viscosity and/or texture properties. In other embodiments, the first gel network can be made from a cocoa product and an aqueous solution, like milk or a milk product. In yet other embodiments, the first gel network can be produced from one or more of milk, water, juice, tea, and/or a potable aqueous solution to form a stable beverage having desirable beverage and viscosity characteristics at room temperature, and even below room temperature. The process of combining the first gel network with other components and/or a second or more gel network can comprise one or more mixing, high speed mixing, or homogenization-types steps from the many available to one of skill in the art. The process differs from previous techniques because, for example, the final solution produced is a stable liquid beverage having a preferred viscosity range from about 0.1 to 0.5 or 0.1 to 1.0 mPas/sec when at room temperature or even at common beverage refrigeration temperatures, and/or the improved mouthfeel and lack of discernable or gritty particles, and/or the especially high concentrations of desired ingredients that can be accommodated (for example, high concentrations of cocoa powder can be stably produced into a beverage composition). The invention also differs in the use of a gel network that can be produced using cocoa ingredients in particular. In many preferred embodiments of the invention, a beverage including a final concentration of about 2% to about 35% cocoa powder or combined cocoa products is specifically noted and described here, which advantageously delivers high concentrations of natural cocoa antioxidants.

As noted, the cocoa-containing product can be a cocoa powder, such as natural cocoa powder, dutched cocoa powder, extra fine or finely ground cocoa powder having average particle sizes less than 30 microns, unroasted cocoa powder, underfermented cocoa powder, unfermented cocoa powder, low roasted cocoa powder, heavily roasted cocoa powder, cocoa products produced from unfermented cacao nibs, cocoa products produced from unroasted cacao nibs, any of these products as an extra fine or finely ground cocoa product or powder having average particle sizes less than 30 microns, or less than 10 microns, or even less than 5 microns, and any combination of these cocoa products or powders. Preferably, a finely ground, low to medium roast cocoa powder is selected. However, in another preferred embodiment, cocoa powder from fermented and heavily roasted, or very dark roast, beans can be used. In addition, various types of defatted or low fat or substantially fat free cocoa powders can be selected and used, such as one of more from the above in a defatted or low fat or fat free state. One skilled in the art is familiar with the different degrees of roasting possible and the use of hygrometers or equilibrium relative humidity measurements to compare the degree of roasting. The cocoa-containing product can also be selected from one or more of: cocoa extracts containing flavanols, baking chocolate, chocolate liquor, cocoa extracts, semisweet chocolate, bittersweet chocolate, and milk chocolate. The invention relates to food products and methods of producing or manufacturing food products that provide healthful benefits of the natural antioxidants found in cocoa and chocolate. In addition to water and aqueous solutions, such as carbonated water and acidified water, the aqueous and liquid solutions that can be used to produce a first or other gel network may comprise one or more of a milk, whole milk, skim milk, 1% milk, 2% milk, coffee, tea, and fruit juices and/or fruit extracts. Various additional components and ingredients can be added, including sweeteners, artificial sweeteners, flavanol-containing extracts, vitamins, hydrocolloids, flavoring, whey, minerals, calcium, fiber, and plant sterols.

In another aspect, the invention comprises a cocoa beverage, such as a gel-in-water suspension, comprising a continuous phase of water or a milk solution and a dispersed phase of cocoa-containing gel micro-particles. The gel micro-particles comprise from about 2% to about 35% cocoa formed from cocoa containing product in a gel network. The typical size of the micro-particles in the suspension is less than about 50 microns in diameter. As in the methods above, various water and aqueous solutions and liquid solutions can be used as the continuous phase, such as one or more of a milk, whole milk, skim milk, 1% milk, 2% milk, coffee, tea, and fruit or vegetable juices and/or extracts. Also as above, various additional components and ingredients can be added, including sweeteners, flavanol-containing extracts, vitamins, hydrocolloids, flavoring, whey, minerals, calcium, plant sterols and fiber. Some of the vitamins that can be used include soluble vitamins, such as vitamin C, vitamin B6 and/or vitamin B12, folic acid, and/or oil soluble vitamins such as vitamin A, beta carotene, vitamin B, the D vitamins, vitamin E, and vitamin K, as well as any mixtures thereof, such as two component, three component, and four component mixtures. One or more vitamins or minerals can be used at a particular RDA amount per unit serving, for example from about 1% to about 100%, or greater than 100%, or about 5 to about 30%, or about 15 to about 20% of the RDA for one or more vitamins or minerals per unit serving. The aqueous or liquid solutions used in the invention can also comprise one or more of water, and water in combination with nutrients, flavorants, sweeteners, carbon dioxide and other gases, and combinations thereof. In another aspect the aqueous solution can be a concentrate of a fruit juice, or fruit flavor, such as citrus juices including orange, lemon, lime, tangerine, mandarin and, grapefruit juice, and other juice and fruit flavor concentrates such as acerola, grape, pear, passion fruit, pineapple, banana, apple, cranberry, cherry, raspberry, peach, plum, grape, currant, cranberry, blackberry, blueberry, pomegranate, acai, strawberry, mirabelle, watermelon, honeydew, cantaloupe, mango, papaya, botanical flavors such as flavors derived from cola, tea, coffee, chocolate, vanilla, almond, vegetable juices and flavors, such as tomato, cabbage, celery, cucumber, spinach, carrot, lettuce, watercress, dandelion, rhubarb, beet, cocona, guava, han guo, and mixtures thereof, such as two component, three component and four component mixtures.

Thus, in one embodiment, the invention describes a cocoa or chocolate composition comprising a gel network formed by cocoa starches and/or proteins that is dispersed as micro-particles into a liquid continuous phase, such as water or milk or skim milk as the continuous phase or aqueous phase of a suspension. Previously, such cocoa and chocolate compositions did not combine a pre-formed gel composition with an aqueous continuous phase.

In a more particular embodiment, the invention comprises a soluble starch or polysaccharide and protein present in at least cocoa solids, or other cocoa product, and present in an amount capable of forming a gel network. The pre-formed gel has a gelatinized structure, and micro-particle of this structure can be produced my mixing, shearing forces, or homogenization. While cocoa-containing compositions are routinely referred to, the invention is not limited to cocoa-containing compositions. Other food ingredients or edible compositions can be used, including separate gel suspensions produced from milk, fruit products, or other protein or starch-containing ingredients.

The methods and ingredients and products of the invention can be used in the production of various chocolate products that fall within the standard of identity for chocolate, milk chocolate, and bittersweet chocolate. Available nutritive or carbohydrate sweeteners that can be selected and used include sucrose, dextrose, fructose, lactose, maltose, glucose, trehalose, oligofructose, inulin, agave syrup, corn syrup, invert sugar, honey, cane syrup, maple sugar, brown sugar, and molasses, for example. Furthermore, artificial or non-nutritive sweeteners can be used in conjunction with the invention, or in total or partial replacement of nutritive sweeteners, to produce low calorie or low carbohydrate products or sugar-free products. Examples of sweeteners include, but are not limited to, Ace-K, sucralose, maltitol, xylitol, erythritol, mannitol, sorbitol, lactitol, isomaltulose, powdered hydrogenated glucose syrup, aspartame, neotame, cyclamate, and any available natural products of plants, such as glycosides and specifically stevioside and rebaudioside A, and any combination of two or more of these sweeteners. Also, vitamin and/or mineral food additives can be optionally added to improve the nutritional content. Alternatively or in addition, plant sterols can be added or used, where plant sterols includes, without limiting to this specific list, phytosterols, phytosterol esters, phytostanols, phytostanol esters, and more particularly various positional isomers, stereoisomers, hydrogenated forms and/or phytostanol esters of the following non-limiting list of general plant sterols: sitosterol, campesterol, stigmasterol, spinosterol, taraxasterol, brassicasterol, desmosterol, chalinosterol, poriferasterol, clionasterol, avenosterol, and ergosterol. The above compounds or extracts containing them can be used alone or in any combination to provide two or more plant sterols or stanols. A non-limiting list of the types of cocoa-containing products that can be used includes: cocoa powder, natural cocoa, cocoa extract, baking chocolate, chocolate liquor, semisweet chocolate, bittersweet chocolate, dark chocolate, and milk chocolate. Cocoa powder that has previously been treated, such as by combining with water or heating with water, can also be used. Various chocolate and cocoa-containing products and compositions noted here refer to the terms as used in Minifie (Chocolate, Cocoa, and Confectionery, 3d ed., Aspen Publishers 1999), specifically incorporated herein by reference. In particular, the cacao bean refers to the cacao bean, also called cocoa bean, in nature and a cocoa-containing product is a product derived from or having some component derived from the cocoa bean. Furthermore, natural cocoa and cocoa powder is not treated with alkaline, processed with alkali, or subjected to other treatments known to the cocoa industry known as “Dutching,” unless it is specifically indicated as dutched, alkalized, or dutch process cocoa. In addition, while a cocoa containing products or extracts having a particular antioxidant, flavanol, or polyphenol level is not required, the invention encompasses the use of one or more cocoa-containing products or extracts with enhanced, altered, or increased levels of antioxidants, flavanols, procyanidins, or polyphenol compounds as compared to conventional cocoa-containing products. A variety of production methods, extraction methods, and the addition of extracts or cocoa-derived polyphenols have been mentioned and can be used by one of ordinary skill in the art to create cocoa compositions of the invention.

As noted, the gel network formation can occur efficiently by heating to a range between about 52° C. to about 68° C. or at or above 70° C. for cocoa-containing compositions. Gel network formation in the same cocoa-containing compositions can also occur through prolonged standing, with or without mechanical shearing. Functionally, the treating or heating step should disrupt the native protein conformation and/or swell carbohydrate or starch or bioploymer components from their existing state in order to form a gel network. Since the swelling of cocoa product components can take long periods of time and/or employ mechanical treatments, the preferred method of preparing a gel network according to this invention is by heating.

In a preferred embodiment, a gel network is made with one or more cocoa powders available and water, optionally cooled, and then mixed with a second gel network made from a milk product or other protein and/or starch-containing edible product. The ultimate product is a cocoa beverage in a flowable form at room temperature, with a high concentration of cocoa, and where the gel component is mixed to form only very small particle sizes compatible with a flowable beverage. Thus, the ultimate product can be referred to as a gel in water suspension. Optionally, additional gel networks or gel in water suspensions can be used. The gel network formed from cocoa powder alone is made as described above or in the examples, or through a process described in co-pending applications US 2006/0121175 and US 2006/0121164, both of which are specifically incorporated herein by reference. Similarly, the second or additional gel networks formed or used can be made from similar or equivalent methods or processes.

In preferred embodiments, the methods and products allow high levels of specific flavanol or antioxidant compounds and mixtures thereof in food or beverage ingredients and the food products themselves. For example, levels of any one or more of the following groups of compounds or individual compounds or isomers of them can be high and still maintain palatable flavor and mouthfeel to the product or ingredient: flavan-3-ol monomers; flavan-3-ol polymers; flavan-3-ol polymers up to 5 units in length; epicatechins; −(−)epicatechin; catechins; (+)-catechin; flavandiols; oligomers of flavandiols; leucocyanidins; quercetin; trans-resveratrol; epigallocatechin (EGC); epigallocatechin gallate (EGCG); (−)-epicatechin gallate; procyanidins; and oligomeric procyanidins. Thus, specific combinations of monomers and polymers can be selected, and specific flavan-3-ol monomer plus polymers levels, for example, can be selected.

Throughout this disclosure, applicants refer to journal articles, patent documents, published references, web pages, and other sources of information. One skilled in the art can use the entire contents of any of the cited sources of information to make and use aspects of this invention. Each and every cited source of information is specifically incorporated herein by reference in its entirety. Portions of any of the articles or sources listed in this document may be included in this document as allowed or required. However, the meaning of any term or phrase specifically defined or explained in this disclosure shall not be modified by the content of any of the articles or sources. The description and examples that follow are merely exemplary of the scope of this invention and content of this disclosure and do not limit the scope of the invention. In fact, one skilled in the art can devise and construct numerous modifications to the examples listed below without departing from the scope of this invention.

### BRIEF DESCRIPTION OF THE DRAWINGS

FIG. 1 depicts a graph of the measured viscosity of a gel-in-water (gel-w) suspension having the final whey protein concentration shown on the lower axis. In each of the FIGS. 1-4, the term “gel” refers to a gel formed but not dispersed into micro-particles in a suspension.

FIG. 2 depicts graph of the measured viscosity of a gel-in-water (gel-w) suspension having the final cocoa powder concentration shown on the lower axis.

FIG. 3 depicts graph of the measured viscosity of a gel-in-water (gel-w) suspension having the final cocoa powder concentration shown on the lower axis, and produced from different speeds on a bench top rotor/stator mixer at room temperature.

FIG. 4 depicts graph of the measured viscosity of a gel-in-water (gel-w) suspension having the final whey protein/cocoa powder concentrations shown on the lower axis, and produced from different speeds on a rotor/stator mixer at room temperature.

FIG. 5 is a photomicrograph of a 1/5 dilution in water of a 25% cocoa powder in water gel dispersed in water by rotor/stator mixing. The larger dark components are insoluble cocoa particles from the cocoa powder, which do not exceed 30 microns in diameter.

FIG. 6 is a photomicrograph of a 1/5 dilution of a 4% whey protein/8% cocoa powder gel dispersed into a gel-in-water suspension.

FIG. 7 schematically depicts a continuous process method for producing the compositions of the invention. The heat exchanger is used to produce the gel composition or gel network, which is mixed with the water or liquid solution. The mixture is optionally sterilized and optionally homogenized before packaging into a final product.

FIG. 8 shows the antioxidant content as measured by ORAC of various cocoa and chocolate compositions. The far right bar “WH Choc Milk” represents the gel-in-water composition of the invention, made from cocoa powder gel and milk as continuous phase.

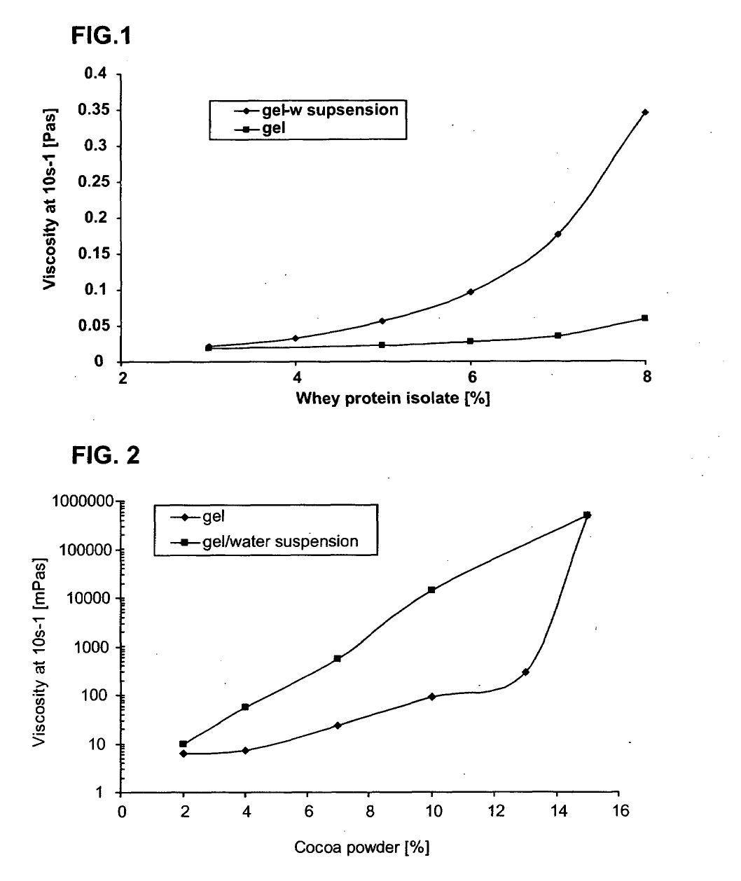

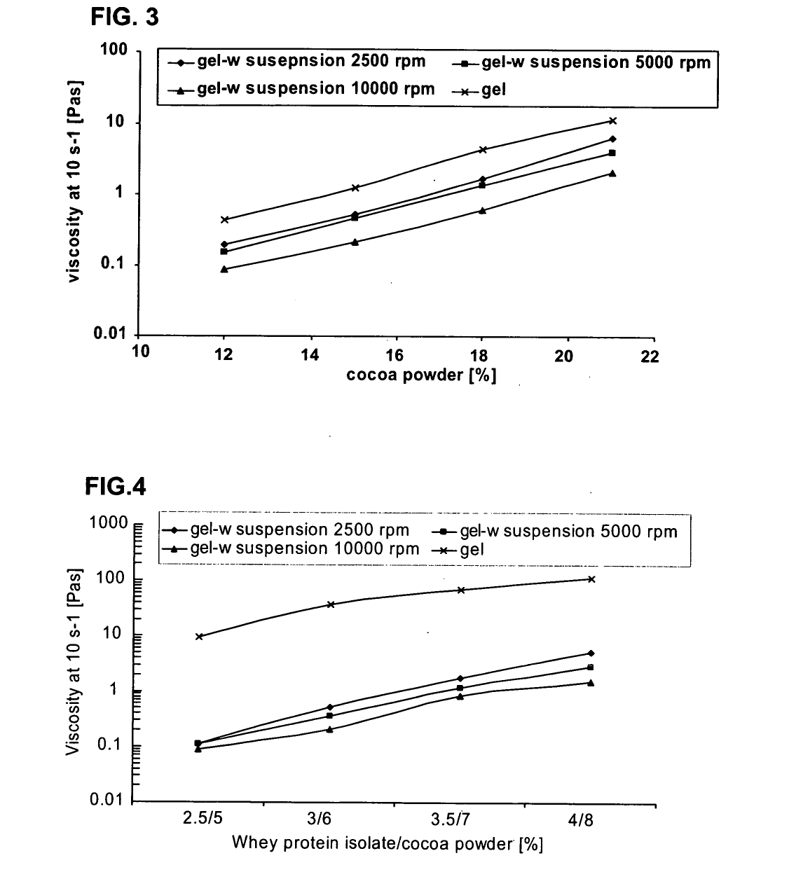

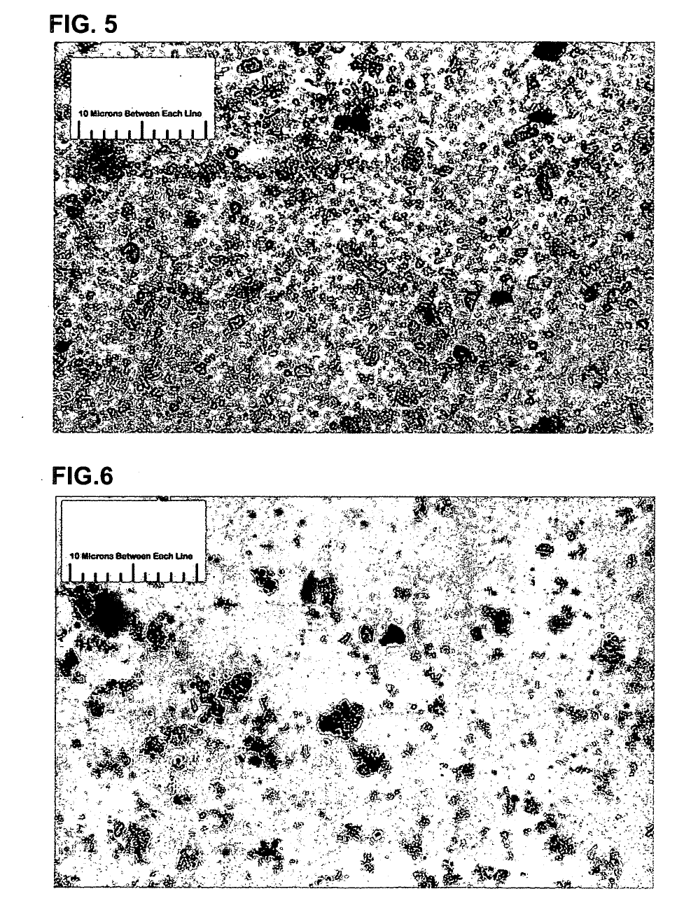

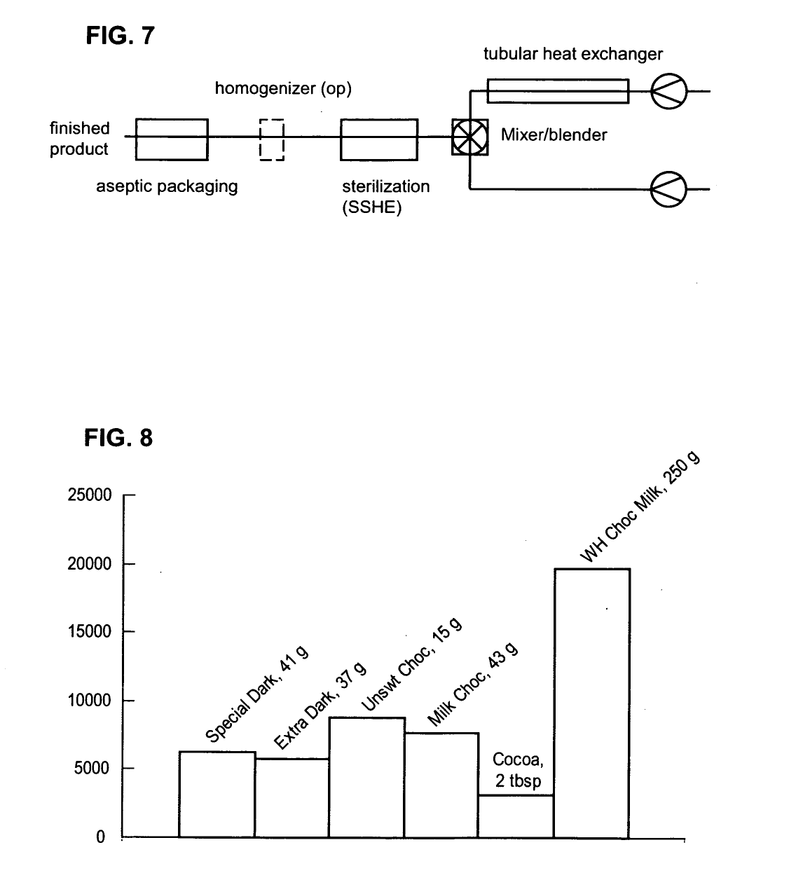

### DETAILED DESCRIPTION OF EXEMPLARY EMBODIMENTS

In a first aspect, the invention involves the novel use of gel networks for producing foods, beverages, and ingredients. As noted, the preferred process for forming a gel network is heating. For the cocoa product containing compositions, heating the mixture can comprise heating to about 68° C. for a period of time sufficient to form a gel network. In general, for cocoa containing products, cocoa starch can be formed into a gel network if it is subjected to a temperature of about 52° C. or above, preferably about 70° C. and above, or about 52° C. to about 68° C., so any heating process that results in the cocoa starch reaching this temperature should suffice. Other, lower temperatures can also be selected and used if longer periods of time are employed. Higher temperatures for heating, for example to about 121° C. for about 8.5 minutes, or to about 150° C. for at least about 4 seconds, can be used in optional processing methods or optional sterilizing methods. Other methods include allowing the mixture to rest at room temperature for a period of time sufficient to form a gel network, or optionally using high shear conditions, for example with a high pressure homogenizer.

In a more general aspect, the invention involves preparing a gel-in-water suspension using the gel network or composition formed from one or more cocoa-containing products. The cocoa containing products are those processed from, or some degree of processed form of, the cacao bean that are available. As noted above, certain microstructure environments can be created using the protein and starch components from cacao bean products. While the production of oil-in-water emulsions in chemical processes is not new, the use of a gel-in-water suspensions for cocoa-containing products in particular, and beverage products and ingredients more generally, is not common.

In another general aspect, the invention comprises preparing an edible, gelatinized gel microstructure and then dispersing into an aqueous system to create a gel-in-water suspension. When cocoa powder is used, this microstructure will also contain insoluble cocoa particles and crystallized cocoa butter if at room temperature or below. A gel network-forming amount of a biopolymer can also be used, wherein the gel network is capable of being formed from the biopolymer before it is later treated or heating to form the final suspension. In advantageous aspects, the use of such a gel or gelatinized microstructure allows the production of highly flavorful and yet flowable beverages at room temperatures, despite having been formed from, or at least optionally formed from, a solid or substantially solid gel material. Compared to other heated cocoa and milk compositions, for example custards or puddings, the use of the methods of the invention provide the ability to produce a flowable, room temperature beverage while the product still possesses the gel components formed in a heating process. The results allow one to select from a variety of rheological properties for compositions having high concentrations of cocoa, for example, and allow the manipulation of the rheological properties and concentrations for these gel-in-water beverages in general. Various combinations of gelatinized or gel materials can be used in combination with the gel formed of cocoa-containing material. One or more separate mixing with a liquid processes can be used with the one or more gels used. Generally, however, the final mixing results in a flowable liquid suspension at room temperature in which the gel particles or solid particles are sufficiently small that it produces a palatable beverage with acceptable mouthfeel. Various particle sizes are listed below and through this document.

By the phrase “stable gel-in-water suspension,” the components of the suspension remain substantially in suspension for a period of up to 3 months, or up to 6 months, or up to 8 months, or up to 12 months, or up to 18 months, or up to 24 months or longer. Some degree of settling is of course allowable and can be expected depending on the ingredients. The micro-particles of the dispersed gel phase can be selected to have a size of about 100 um or less in diameter while in the suspension, and preferably less than 50 um, and even more preferably from about 10 um to about 20 um in average diameter. In the most preferred embodiments, the micro-particles are below 10 um in average size and/or can be made using a very finely ground cocoa powder, below 50 um, or below 20, or below 10 um, or about 4 um in average cocoa particle size. In general, the average micro-particle size discussed here refers to a distribution of sizes where, for example, a cocoa powder is ground so that 85% of the particles present are at or below the average size noted. Many standard measuring techniques can be used to measure this average particle size, including microscopic analysis and light-scattering methods, as known in the art. Generally then, a beverage composition that has substantially all particles less than 100 microns will have an average size below 100 microns in diameter and/or, according to other characteristics, will generally produce an acceptable beverage mouthfeel and not contain undesirable visible particles.

In another aspect, the edible gel-in-water suspension of this invention refers to a dispersed phase of gel micro-particles and insoluble particles that are suspended in a substantially stably manner within an aqueous continuous phase. While cocoa-based gel-in-water suspensions are noted as a preferred embodiment, other biopolymer-containing compositions can be used also to form a gel network or composition.

The formation of a gel network can be detected by a variety of methods known in the art, including microscopy, direct viscosity measurements, ultrasonic methods, and light scattering methods. If a viscosity measurement is used, one preferred detectable change is where the viscosity of the suspension increases after heating when measured as shear rate. More particularly, the viscosity increase is at least about two-fold or double in the measurable 30 sec-1 shear rate. If microscopy is used, one of skill in the art can measure gel formation by the effects on the final suspension and the appearance of component parts within the suspension. For example, starch granules in cocoa-containing compositions can be visualized prior to swelling but not after gelatinization. Cocoa butter droplets or small particles can be visualized in the suspension at about room temperature in the range of between 0.5-100 um, or between 0.5-30 um.

In addition, while a cocoa-containing product having a particular antioxidant or polyphenol level is not required, the invention encompasses the use of cocoa containing products with enhanced, altered, or increased levels of anti-oxidants or polyphenol compounds as compared to conventional cocoa containing products. Other nutritional, therapeutic, or preventative ingredients can be added as well, as known in the art.

While this disclosure and the examples refer in particular to chocolate and cocoa-containing products or ingredients, the invention is not limited to chocolate and cocoa products. In fact, any food product that is made under conditions where polyphenols or antioxidants are susceptible to degradation could benefit from the invention and the methods disclosed here.

For the cocoa-containing food products, we refer generally to cocoa powder as cocoa solids with a total of about 10% to 12% fat, where the fat is generally cocoa butter. Other forms of cocoa, cocoa-containing products or ingredients can be used, for example: breakfast cocoa is cocoa solids with 20 to 24% fat, where the fat is generally cocoa butter; and chocolate liquor (or cocoa liquor) is ground cocoa nibs and it can be separated into cocoa butter and cocoa solids. The terms chocolate, milk chocolate, semisweet chocolate, bittersweet chocolate, and dark chocolate, are as used commonly in the U.S. food industry and do not imply, unless stated otherwise any particular composition.

In making and using aspects and embodiments of this invention, one skilled in the art may employ conventional techniques. Exemplary techniques are explained fully in the literature and are well known in the art.

### Exemplary Embodiments

The following examples show the utility and advantages of the invention, but should not be taken as a limit to, and are not intended to limit or confine, the scope or extent of the invention. Obviously, the amounts and measurements given are merely exemplary understood in the art to produce similar results. All quantities expressed in percentages are percentages by weight, unless otherwise indicated.

In the examples below, a gel network composition is prepared from the preferred ingredient, cocoa powder, by heating a 25% composition of finely ground cocoa powder in water to about 70 degrees C. or higher, and optionally cooling, to form a gel, referred to as “CP gel” below. Alternatively, the CP gel can be prepared by pressure cooking for 30 minutes at 15 psi. The method of producing the gel network is not especially important to the method of producing a beverage of the invention, as long as the stable gel network is formed from the protein and/or starch components present. The use of a 25% cocoa powder composition is an example and demonstrates the relatively high concentrations of cocoa products that can be used to produce a palatable beverage according to the invention. In fact, the invention can be used to produce highly concentrated beverages for the delivery of beneficial amounts of cocoa antioxidants in the diet, especially when additionally prepared as an optional sugar-free composition.

Some of the examples below also refer to a second gel, a milk gel. Various milk gels can be used, but those referred to below can be Milk Gel #1, which is about 20% Non Fat Dry Milk, 10% Sugar/Sucrose, 4% Whey, and 66% water, which can be pressure cooked for 30 minutes at 15 psi. The Milk Gel #2 can be 20% Non Fat Dry Milk, 10% Sugar/Sucrose, 4% Whey, 2% Cocoa Powder, and 64% water, which is pressure cooked for 30 minutes at 15 psi. The Milk Gel #3 can be 18% Non Fat Dry Milk, 10% Sugar/Sucrose, 3% Whey, and 77% water, which is pressure cooked for 30 minutes at 15 psi. Generally, though not necessarily, the gel compositions are cooled after the heating step, however the gel can be used immediately after it is formed and processed with water or liquid to product the gel in water suspension.

The aqueous or liquid solutions used can vary from a number of typical beverage type products and compositions, such as water, milk, 2% milk, 1% milk, skim milk, coffee, tea, fruit juices, water containing edible extracts, and various other solutions. For the purposes here, these liquid solution need not be pure solutions in the sense that solutes will not come out of solution at room temperature over time. The liquid solutions need only be stable solutions as generally understood for food and beverages, such as milk, coffee, and tea. These are generally regarded as stable solutions for mass production, distribution, and consumption, and any similar liquid solutions can be used according to the invention. A more particular, but non-limiting list of some of the aqueous or liquid solutions that can be used includes water in combination with nutrients, flavorants, sweeteners, carbon dioxide and other gases, fruit or vegetable juice or flavor or concentrates thereof, such as citrus juices, and juice or extract or concentrates of orange, lemon, lime, tangerine, mandarin, grapefruit, acerola, grape, pear, passion fruit, pineapple, banana, apple, cranberry, cherry, raspberry, peach, plum, grape, currant, cranberry, blackberry, blueberry, pomegranate, acai, strawberry, mirabelle, watermelon, honeydew, cantaloupe, mango, papaya, botanical flavors such as flavors derived from cola, tea, coffee, chocolate, vanilla, almond, vegetable juices and flavors, such as tomato, cabbage, celery, cucumber, spinach, carrot, lettuce, watercress, dandelion, rhubarb, beet, cocona, guava, han guo, and mixtures thereof, such as two component, three component and four component mixtures.

The gel composition can be added to the liquid solution and then mixed at high speed to produce the micro-particles. As explained above, the gel micro-particles can be of various size ranges, but generally less the 50 or less than 100 microns. Larger than 100 microns produces a mouthfeel generally not acceptable for a beverage, or the undesirable appearance of visible particles. The average particle size range can vary also, for example less than 50 microns, less than 10 microns, or ranges from about 10-30, 20-30, 2040, 20-50 all generating acceptable examples.

| Ingredient | Example #1 |
|---|---|
| 25% Cocoa Powder Gel | 28% |
| Sugar/Sucrose | 10% |
| Water | 62% |

| Ingredient | Example #2 |
|---|---|
| 25% CP Gel | 28% |
| Sugar/Sucrose | 10% |
| Skim Milk | 62% |

| Ingredient | Example #3 |
|---|---|
| 25% CP Gel | 12% |
| Sugar/Sucrose | 8% |
| Water | 71% |
| Milk Gel #3 | 9% |

| Ingredient | Example #4 |
|---|---|
| 25% CP Gel | 35% |
| Sugar/Sucrose | 13% |
| Skim Milk | 27% |
| Milk Gel #1 | 25% |

| Ingredient | Example #5 |
|---|---|
| 25% CP Gel | 35% |
| Sugar | 13% |
| Skim Milk | 27% |
| Milk Gel #2 | 25% |

| Ingredient | Example #6 |
|---|---|
| 25% CP Gel | 31% |
| Sugar | 14% |
| Skim Milk | 27% |
| Milk Gel #3 | 28% |

| Ingredient | Example #7 |
|---|---|
| 25% CP Gel | 18% |
| Sugar | 2% |
| Water | 73.967% |
| Sucralose | .03% |
| Ace-K | .003% |
| Milk Gel #3 | 6% |

| Ingredient | Example #8 |
|---|---|
| 25% CP Gel | 35% |
| Sucralose | 0.05% |
| salt | 0.03% |
| Vanilla | 0.05% |
| Milk | 64.87 |

| Ingredient | Example # 9 |
|---|---|
| 25% CP Gel | 35% |
| Sucralose | 0.05% |
| Milk | 64.95 |

| Ingredient | Example # 10 |
|---|---|
| 25% CP Gel | 35% |
| Sucralose | 0.04% |
| Ace K | 0.003% |
| salt | 0.03% |
| Vanilla | 0.05% |
| Milk | 64.877 |

After producing the gel noted (such as CP Gel or Milk Gel), the cooled gel composition having a gelatinized structure is mixed in the percentages noted above with bench top rotor/stator type mixer at room temperature at about 2500 rpm. As shown in the Figures, different mixing speeds can also be selected and used. Other types of mixers and homogenizers can also be used, and inline mixers can be adapted for production processes. The examples above represent the ingredients as a percent of the total weight used in the mixing composition. In each case, the final beverage product has an acceptable mouthfeel and good flavor.

In another example, a high antioxidant cocoa beverage is produced containing about 9% cocoa powder in a final form. The method begins with a cocoa powder gel network produced from a solution of 25 to 28% cocoa powder in water or milk, such as skim milk, non-fat dry milk in water, low fat, or regular milk, that is pressure treated for about 15 to 30 mins at 15 psi and about 50-70 degrees C. A variety of sweetening agents and compositions can also be used. For example, sucrose from about 10 to 15% for final products that contain nutritive sugars. Sugar-free final products are preferred, however, and a number of known sweeteners, such as Ace-K, sucralose, maltitol, and combinations of know sweeteners can be selected. Additional ingredients that can traditionally be used with cocoa and milk beverages can also be used, such as whey proteins at about 3 to 4%, if desired. The gel is then cooled, diluted 1:3 with water, mixed in a Silverson mixer at about 8000 rpm for about 40 seconds, and then diluted with water 1:3 again. The final beverage product has an intense cocoa flavor and contains healthy amounts of cocoa antioxidants. It is stable and no detectable separation of components is visible after refrigerated storage for months. The product can also be sterilized, for example, through heating and retort processes know in the art. In some embodiments a dynamic sterilization method may be preferred for the beverage compositions of the invention, or the final composition can be hot filled into containers to sterilize, or static heating, retort, or aseptic conditions can be used in processing to a final product. In other embodiments, for example those where coffee, a coffee-type, tea or other acidic solution is employed as all or part of the aqueous solution to disperse the first gel network composition, or is used elsewhere in the processing, the combination of low acidity, on the order of pH 4 or lower, and temperatures of about 75 degrees C. can be used to sterilize, as known in the art

The examples presented above and the contents of the application define and describe examples of the many food products, baked products, and methods for producing food products according to the invention. None of the examples and no part of the description should be taken as a limitation on the scope of the invention as a whole or of meaning of the following claims.

What is claimed is:

1. A method of producing a beverage composition comprising heating a composition comprising at least about 2% of a cocoa-containing product in water or an aqueous solution to form a gel network composition, optionally cooling the gel network composition, mixing the gel network composition with water or an aqueous solution under conditions that form a suspension of gel micro-particles having substantially all micro-particles less than about 100 microns in diameter, wherein the composition is flowable at room temperature.

2. The method of claim 1, wherein the cocoa-containing product is a cocoa powder.

3. The method of claim 2, wherein water is used to form a gel network composition.

4. The method of claim 1, wherein the aqueous solution is milk, coffee, tea, fruit juice, or vegetable juice.

5. The method of claim 2, wherein the micro-particles are less than about 50 microns in diameter.

6. The method of claim 5, wherein the average size of the micro-particles is about 10 to 20 microns.

7. The method of claim 5, wherein the average size of the micro-particles is less than about 10 microns.

8. The method of claim 2, wherein the aqueous solution used comprises one or more of milk, skim milk, non-fat dry milk in water, coffee, tea, vegetable juice, and fruit juice.

9. The method of claim 1, wherein the cocoa-containing product contains cocoa solids and is selected from one or more of: cocoa extracts containing flavanols, baking chocolate, chocolate liquor, semisweet chocolate, bittersweet chocolate, defatted cocoa, fat free cocoa powder, and milk chocolate.

10. The method of claim 1, further comprising adding a sweetener or artificial sweetener.

11. The method of claim 10, wherein the sweetener is one or more of sucralose, aspartame, neotame, and Ace-K.

12. The method of claim 2, wherein the cocoa powder is present at about 4% to about 35%.

13. The method of claim 2, wherein the cocoa powder is present at about 6% to about 20%.

14. The method of claim 2, wherein the cocoa powder is present at about 3% to about 10%.

15. The method of claim 2, wherein the cocoa powder is from one or more of fermented beans, low roast beans, medium roast beans, and high roast beans.

16. The method of claim 2, wherein the cocoa powder is from unfermented, underfermented, or unroasted cacao beans.

17. The method of claim 2, further comprising adding a hydrocolloid.

18. The method of claim 2, wherein the mixing is performed in a rotor/stator type mixer at about 2500 rpm or higher.

19. The method of claim 2, wherein the mixing is a homogenization.

20. The method of claim 2, further comprising adding whey.

21. The method of claim 2, wherein the aqueous solution comprises substantially no hydrocolloids.

22. A cocoa beverage suspension comprising a continuous phase of water or a milk solution and a dispersed phase of cocoa-containing gel micro-particles, wherein the gel micro-particles comprise from about 2 to about 35% cocoa formed from heating a cocoa powder product into a gel network, and wherein substantially all of the micro-particles in the suspension are less than about 50 microns in diameter.

23. The cocoa beverage of claim 22, wherein the average size of the micro-particles is between about 10 to about 20 microns.

24. The cocoa beverage of claim 22, wherein the average size of the micro-particles is at or below about 10 microns.

25. The cocoa beverage of claim 22, further comprising one or more artificial sweeteners.

26. The cocoa beverage of claim 22, further comprising at least one sweetener selected from sucralose, sucrose, aspartame, neotame, and Ace-K.

27. The cocoa beverage of claim 22, wherein the final cocoa powder concentration is about 3% to about 20%.

28. The cocoa beverage of claim 22, wherein the final cocoa powder and cocoa product content is about 7% to about 12%.

29. The cocoa beverage of claim 25, where the product is substantially sugar-free.

30. The cocoa beverage of claim 25, further comprising about 3-4% whey proteins.

31. The cocoa beverage of claim 22, further comprising one or more of milk proteins, soy proteins, and whey.

32. The cocoa beverage of claim 22, wherein skim milk is the continuous phase.

33. The cocoa beverage of claim 22, wherein 2% milk is the continuous phase.

34. The cocoa beverage of claim 22, wherein 1% milk is the continuous phase.

35. The cocoa beverage of claim 22, wherein whole milk is the continuous phase.

36. The cocoa beverage of claim 22, wherein the cocoa powder is from fermented and roasted cacao beans.

37. The cocoa beverage of claim 22, wherein the cocoa powder is from unfermented, underfermented, or unroasted cacao beans.

38. The cocoa beverage of claim 37, further comprising a sweetener is selected from sucralose, sucrose, aspartame, neotame, and Ace-K, and wherein the concentration of cocoa powder is about 8 to 10%.

39. The cocoa beverage of claim 22, further comprising a plant sterol, plant stanol, or esters thereof.

40. The cocoa beverage of claim 22, further comprising one or more vitamins or minerals.

41. The cocoa beverage of claim 22, wherein the viscosity at room temperature is about 0.1 to about 1.0 mPas/sec.

42. The cocoa beverage of claim 24, wherein the viscosity at room temperature is about 0.1 to about 1.0 mPas/sec.

43. The cocoa beverage of claim 27, wherein the viscosity at room temperature is about 0.1 to about 1.0 mPas/sec.

44. A method of producing a beverage composition comprising heating a composition comprising at least about 2% of a cocoa powder in water or an aqueous solution to form a gel network composition, optionally cooling the first gel composition, forming a second gel network composition with water or an aqueous solution and milk or whey products, optionally cooling the second gel composition, and mixing the first and second gel network compositions under conditions that form a suspension of gel micro-particles having substantially all micro-particles less than about 100 microns in diameter, and wherein the beverage composition is flowable at room temperature.

45. The method of claim 44, wherein the cocoa powder is finely ground to an average size distribution where 85% of particles are about 10 microns or less in diameter.

46. The method of claim 44, wherein the mixing is performed in a rotor/stator type mixer at about 2500 rpm or higher.

47. The method of claim 44, wherein the mixing is a homogenization.

48. The method of claim 44, wherein the aqueous solution comprises substantially no hydrocolloids.

49. The method of claim 44, wherein the cocoa powder is from fermented and roasted cacao beans.

50. The method of claim 44, wherein the cocoa powder is from unfermented, underfermented, or unroasted cacao beans.

51. The method of claim 44, further comprising a sweetener is selected from sucralose, sucrose, aspartame, neotame, and Ace-K.

52. A product produced from the method of claim 44, wherein the concentration of cocoa powder is about 8 to 10%.

53. A product produced from the method of claim 51, wherein the concentration of cocoa powder is about 8 to 10%.

54. The product of claim 52 that is sterilized.

55. The product of claim 53 that is sterilized.

56. The cocoa beverage of claim 22, further comprising one or more nutritive sweeteners sucrose, dextrose, fructose, lactose, maltose, glucose, trehalose, oligofructose, inulin, agave syrup, corn syrup, invert sugar, honey, cane syrup, maple sugar, brown sugar, and molasses.

57. The cocoa beverage of claim 22, further comprising one or more artificial or non-nutritive sweeteners Ace-K, sucralose, maltitol, xylitol, erythritol, mannitol, sorbitol, lactitol, isomaltulose, powdered hydrogenated glucose syrup, aspartame, neotame, and cyclamate.

58. The cocoa beverage of claim 22, further comprising a juice, concentrate, extract, or flavor extract of orange, lemon, lime, tangerine, mandarin, grapefruit, acerola, grape, pear, passion fruit, pineapple, banana, apple, cranberry, cherry, raspberry, peach, plum, grape, currant, cranberry, blackberry, blueberry, pomegranate, acai, strawberry, mirabelle, watermelon, honeydew, cantaloupe, mango, papaya, tea, coffee, chocolate, vanilla, almond, tomato, cabbage, celery, cucumber, spinach, carrot, lettuce, watercress, dandelion, rhubarb, beet, cocona, guava, or han guo.

56. The product produced from the method of claim 44, further comprising one or more nutritive sweeteners sucrose, dextrose, fructose, lactose, maltose, glucose, trehalose, oligofructose, inulin, agave syrup, corn syrup, invert sugar, honey, cane syrup, maple sugar, brown sugar, and molasses.

57. The product produced from the method of claim 44, further comprising one or more artificial or non-nutritive sweeteners Ace-K, sucralose, maltitol, xylitol, erythritol, mannitol, sorbitol, lactitol, isomaltulose, powdered hydrogenated glucose syrup, aspartame, neotame, and cyclamate.

58. The product produced from the method of claim 44, further comprising a juice, concentrate, extract, or flavor extract of orange, lemon, lime, tangerine, mandarin, grapefruit, acerola, grape, pear, passion fruit, pineapple, banana, apple, cranberry, cherry, raspberry, peach, plum, grape, currant, cranberry, blackberry, blueberry, pomegranate, acai, strawberry, mirabelle, watermelon, honeydew, cantaloupe, mango, papaya, tea, coffee, chocolate, vanilla, almond, tomato, cabbage, celery, cucumber, spinach, carrot, lettuce, watercress, dandelion, rhubarb, beet, cocona, guava, or han guo.

59. The method of claim 1, further comprising sterilizing the beverage.

60. The method of claim 2, further comprising sterilizing the beverage.

61. The method of claim 3, further comprising sterilizing the beverage.
